(19) United States
(12) Patent Application Publication
(10) Pub. No.: US 2008/0190461 A1
(43) Pub. Date: Aug. 14, 2008

(54) Overhead Rail Cleaner

(76) Inventor: James Christopher Thorpe, Northamptonshire (GB)

Correspondence Address: Paul E. Milliken, 9061 Wall Street, NW, Massillon, OH, 44646-1676, US

(21) Appl. No.: 11/661,463

(22) PCT Filed: Aug. 23, 2005
(86) PCT No.: PCT/GB2005/003284

§ 371 Date: Dec. 7, 2007

(30) Foreign Application Priority Data
Aug. 27, 2004 (GB) 0419101.1

(51) Int. Cl. B65G 45/18; A47L 9/00; B08B 1/04; A47L 5/12; A47L 25/00; A46B 13/02

(52) U.S. Cl. 134/42; 15/340.4; 15/21.1; 15/88.4; 15/312.1

(57) ABSTRACT

An overhead rail system cleaning device 20 has a body 21 with rollers 23 mounted thereon for suspension of and movement along the rail 11, cleaning brushes 41 mounted on the body 21 for cleaning the rail 11, and preferably suction device 61 also mounted on the body 21 and having at least one air intake port 62 adjacent the cleaning brushes 41 for collection of dirt and dust particles removed from the rail. The cleaning device 21 can moved in use along the rail 11 by a drive wheel 51 mounted on the body 21 and resiliently biased against the rail.

### FIELD

This invention relates to a cleaning device for an overhead rail system for materials handling, and is especially for use for cleaning rail systems used in commercial laundries.

### BACKGROUND

In commercial laundries, dirty laundry and clean laundry are generally moved about the premises in collapsible bags which are supported at their upper ends by a rigid ring. These rings in turn are generally supported from wheeled trolleys which are movable on overhead conveyor rails to facilitate movement of the laundry bags around the site. The rails provide a track for the movement of the trolleys and the rail systems are generally inclined to the horizontal in order to use gravity to assist in the transfer of bags around the laundry.

The overhead rail system tends to collect dirt and dust over a prolonged period of time and it is possible for the dust/dirt to be transferred to clean laundry. This is obviously highly undesirable and the present invention provides for an overhead rail cleaning device. Such devices are known in other industries, see for example U.S. Pat. No. 4,019,492 and U.S. Pat. No. 5,671,839 but are unsuitable for use in commercial laundries because the dirt removed from the rail is widely scattered by the cleaning brushes.

U.S. Pat. No. 3,641,618 discloses a rail cleaner having a vacuum cleaner device for picking up the dust and dirt removed from the rail. The cleaner device is suspended from a carriage mounted on a driven trolley wheel which rides on the top of the rail. The whole weight of the cleaner is taken by the single trolley wheel which also acts as the driving wheel and this may lead to mechanical breakdown.

The present invention seeks to provide an improved rail cleaner.

### STATEMENT OF INVENTION

Accordingly there is provided an overhead rail cleaner for an comprising a body with rollers mounted thereon for suspension of the body from a rail and for movement along the rail, cleaning brushes mounted on the body for cleaning the rail, the cleaning device in use being moved along the rail by at least one drive wheel mounted on the body and resiliently biased against the rail.

An advantage of the present invention is that substantially all the rail cleaner is located below the top of the rail.

Preferably, the brushes clean the sides of the rail and are rotary circular brushes having axes of rotation normal to the rail. The brushes may be mounted on a strut which is adjustably mounted to the body.

The drive wheel in use does not carry the weight of the cleaner and is resiliently biased against the underside of the rail. The drive wheel is spring loaded against the rail and is driven by an electric motor mounted on the body.

The cleaner may further comprise a suction device also mounted on the body and having at least one air intake port adjacent the cleaning brushes for collection of dirt and dust particles removed from the rail.

The brushes may be powered rotary brushes and the drive wheel and the brushes be driven by the same electric motor. The motor may be a DC electric motor which may be powered by a battery also mounted on the body. The motor may be a reversible drive motor allowing the brushes and drive wheel to be operated in two rotational directions. The drive wheel and brushes may be operated through gear trains and/or drive belts.

The operation of the brushes, suction device, and drive wheel may be controlled through a pre-programmable control unit which may be operated through a remote control unit.

In general, the cleaning device is an independent autonomous unit which can be sent around an empty rail network to clean the rails when the system is not in use.

The cleaning device may be substantially enclosed within a removable housing, which may comprise several panels, mounted on the body.

The rollers may formed on a trolley having a similar construction to the trolley described in GB 2317 866 in which the planes of rotation of the rollers on the two arms converge towards the load with a mutual angle therebetween in the range of 40-70 degrees of arc, preferably about 50 degrees.

A further aspect of the invention provides a cleaning device for an overhead rail system and which comprises a body with rollers mounted thereon for suspension of the body from the rail and for movement of the body along the rail, cleaning brushes mounted on the body for cleaning opposite sides of the rail, wherein the brushes are powered rotary brushes having axes of rotation normal to the rail and which are driven by an electric motor mounted on the body.

Another aspect of the invention provides a method of cleaning the overhead rail conveyor system in a commercial laundry using a cleaning device as disclosed herein.

### DESCRIPTION OF DRAWINGS

The invention will be described by way of example and with reference to the accompanying drawings in which:

FIG. 1 is a side view of an overhead rail and cleaning device according to the present invention,

FIG. 2 is an isometric view of the cleaning device with some components removed for clarity, and

FIG. 3 is a front view of the cleaning device also with components omitted.

### DETAILED DESCRIPTION OF INVENTION

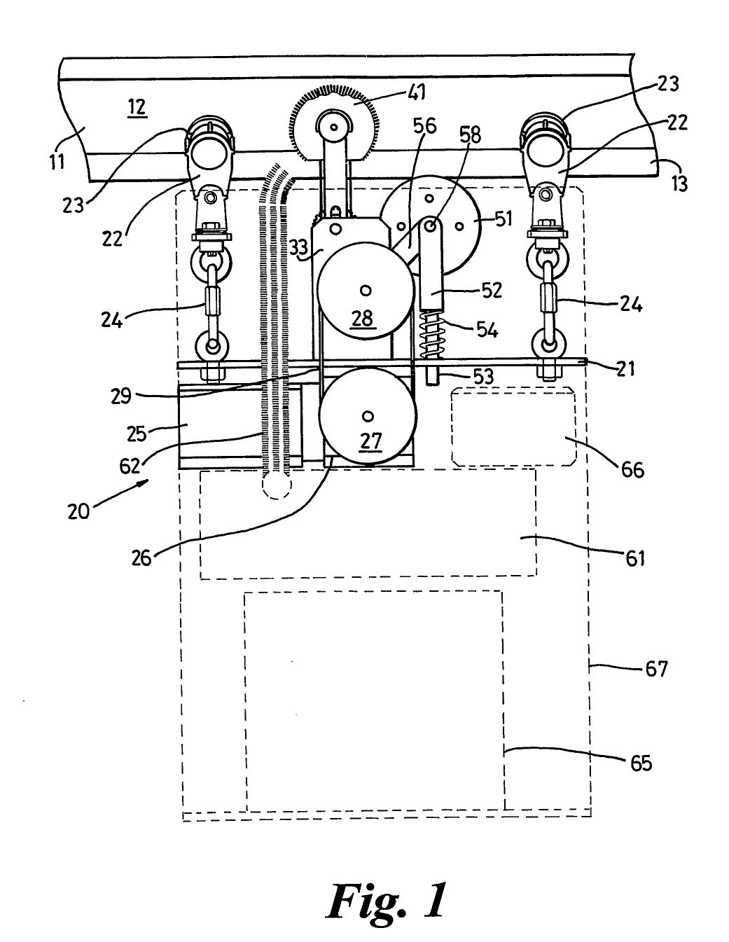

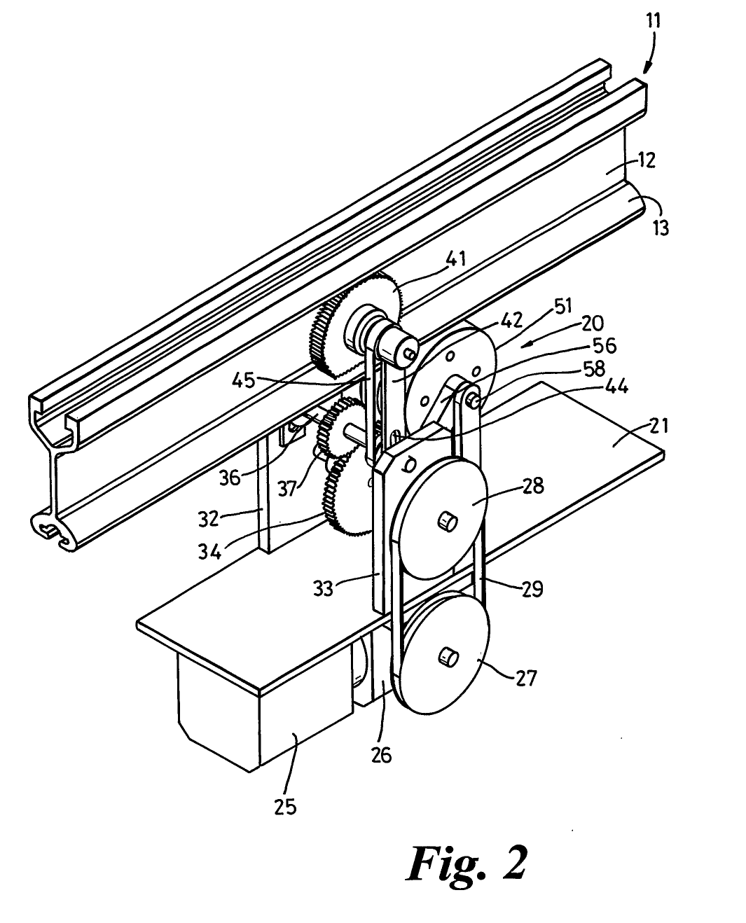

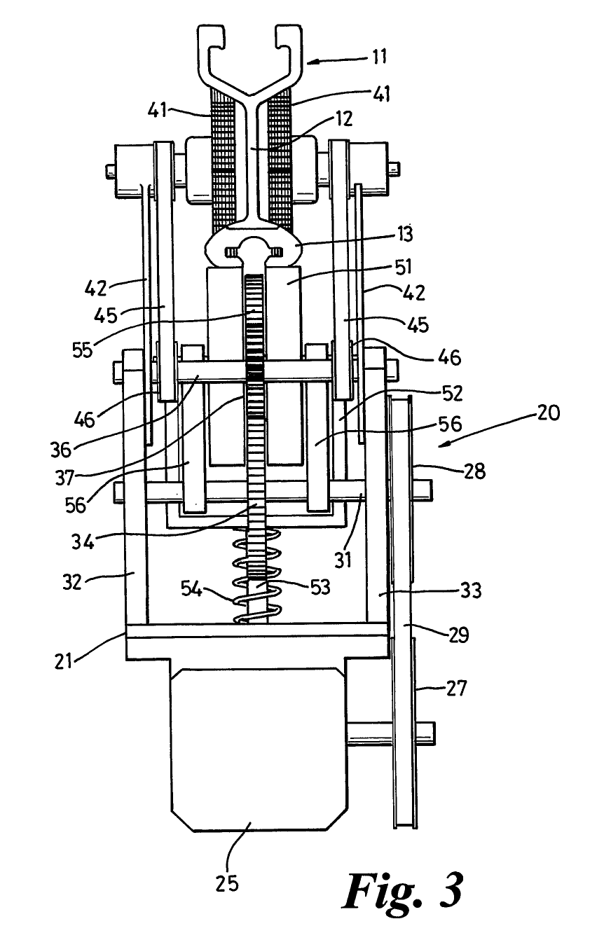

With reference to FIGS. 1 to 3 of the drawings there is shown a section of overhead rail 11 having a central web 12 with a lower track portion 13 symmetrically arranged at its lower end. The track portion 13 has an upper surface on each side of the web 12 along which a cleaning device 20 according to the present invention can move. In use the rail 11 forms part of an overhead conveyor system for the movement of laundry bags around a commercial laundry.

The cleaning device 20 comprises a planar body 21 which is made from a suitable material which could be steel plate. The body 21 is suspended from the overhead rail 11 by a pair of trolleys 22 located one at each end portion of the body. The trolleys 22 are shown only in FIG. 1 and are similar to those described in GB 2317866 where further details may be obtained. Each trolley 22 is basically ‘Y’ shaped having two diverging arms and a vertical leg. Each arm has a roller 23 mounted at its upper end portion on its inner side adjacent the rail so that a roller 23 is located on each side of the web 12 with the rollers moving along the track portion 13. The planes of rotation of the two rollers 23 are inclined to the vertical in use and converge with a mutual angle therebetween of between 40-70 degrees and preferably about 50 degrees. A steel shackle 24 secures the body 21 to each trolley 22.

A DC motor 25 and gear box 26 are secured to the under side of the body 21. The motor 25 drives a pulley 27, via the gearbox 26, which in turn drives a second pulley 28 via a belt 29. The pulley 28 is rotatably mounted at one end of a first shaft 31 rotatably supported between a pair of brackets 32,33 on the upper side of the body 21. A drive gear wheel 34 is mounted on the shaft 31 rotationally fast therewith between the two brackets 32,33.

A pair of circular cleaning brushes 41 are located one on each side of the rail web 12 with their axes of rotation normal to the rail. The brushes 41 are each rotatably supported at the upper end of a strut 42 fixed to a respective bracket 32 or 33. Each strut 42 is adjustably secured relative to its respective bracket 32 or 33 using a fastener (bolt, screw etc.) which passes through an elongate slot 44 in the strut. The brushes 41 are each driven by a respective belt 45 which in turn is driven by a pulley 46 fixed on a second shaft 36. The second shaft 36 is also rotatably supported between the brackets 32,33 and has a gear wheel 37 fast thereon which meshes with the gear wheel 34 on the first shaft 31. The gear ratio of gear wheel 34:gear wheel 37 is 2:1 approx.

A drive wheel 51 is rotatably mounted in a fork 52 whose stem 53 passes downwards through the body 21. The wheel 51 is resiliently biased into frictional engagement with the underside of the rail 11, preferably by a spring 54 acting between the body 21 and the fork 52. The spring 54 is a coil spring arranged concentrically with the stem 53. The drive wheel 51 comprises two outer circular portions with a driven gear wheel 55 located axially therebetween. The driven wheel gear 55 meshes with the drive gear 34, the two gears having a 1:1 ratio. The vertical movement of the drive wheel 51 is guided by two guide struts 56 which are pivotally connected at their one ends to the first shaft 31 and at their other ends to the axle 58 for the wheel 51. The stem 53 passes loosely through an aperture in the body 21 to allow for any lateral movement caused by the rotational movement of the guide struts about the first shaft.

It can be seen that the DC motor drives both the brushes 41 and the friction drive wheel 51.

Also supported on the underside of the body 21 is a DC powered vacuum cleaner 61 having at least one suction pipe 62, preferably one per brush, extending towards the cleaning brushes. The vacuum cleaner 61 collects any particulate matter removed from the rail by the cleaning brushes. The power for the DC motor 25 and the vacuum cleaner 61 is supplied by at least one battery unit 65 also mounted on the body 21.

The operation of the motor 25 and vacuum cleaner 61 is controlled by a pre-programmed control unit 66 also mounted on the body 21. The control unit 66 may include a receiver which is responsive to signals from a remote control.

The whole cleaning device may be substantially enclosed within a housing 67, preferably made from stainless steel and formed from one or more parts.

In general, the cleaning device is an independent autonomous unit which can be sent around an empty rail network to clean the rails when the system is not in use.

What is claimed is:

1. An overhead rail cleaner for an overhead rail system and which comprises a body with rollers mounted thereon for suspension of the body from the rail and movement of the body along the rail, cleaning brushes mounted on the body for cleaning the rail, wherein at least one drive wheel is mounted on the body and in use is resiliently biased against the rail to move the device along the rail.

2. A cleaner as claimed in claim 1 wherein the brushes are rotary circular brushes having axes of rotation normal to the rail.

3. A cleaner as claimed in claim 2 wherein the brushes are mounted on a strut which is adjustably secured to the body.

4. A cleaner as claimed in claim 1, wherein the drive wheel in use is resiliently biased against the underside of the rail.

5. A cleaner as claimed in claim 4 wherein the drive wheel is spring loaded against the rail and is driven by an electric motor mounted on the body.

6. A cleaner as claimed in claim 1, wherein the brushes are powered rotary brushes driven by an electric motor mounted on the body.

7. A cleaner as claimed in claim 6 wherein the brushes are driven by the same electric motor as is used to power the drive wheel.

8. A cleaner as claimed in claim 7 wherein the motor is a DC electric motor powered by a battery mounted on the body.

9. A cleaner as claimed in claim 8, wherein the motor is a reversible drive motor allowing the brushes and drive wheels to be operated in two rotational directions.

10. A cleaner as claimed in claim 1, wherein a suction device is mounted on the body and has at least one air intake port adjacent the cleaning brushes for collection of dirt and dust particles removed from the rail.

11. A cleaner as claimed in claim 10, wherein the suction device is an electrically powered vacuum cleaner.

12. A cleaner as claimed in claim 1, and further comprising a pre-programmable control unit which monitors and controls the operation of the brushes, suction device, and any drive wheel.

13. A cleaning device as claimed in claim 12, wherein the control unit is operable by a remote control device.

14. A cleaning device as claimed in claim 1, wherein the cleaning device is substantially enclosed within a removable housing, comprising at least one removable panel, which is also mounted on the body.

15. An overhead rail cleaner for an overhead rail system and which comprises a body with rollers mounted thereon for suspension and movement of the body along the rail, and cleaning brushes mounted on the body for cleaning opposite sides of the rail, wherein the brushes are powered rotary brushes having axes of rotation normal to the rail and which are driven by an electric motor mounted on the body.

16. A method of cleaning the rail of an overhead rail conveyor system in a commercial laundry in which a cleaner in accordance with claim 1, is sent around an empty rail network for cleaning the rail.
